(19) United States
(12) Patent Application Publication
(10) Pub. No.: US 2024/0070654 A1
(43) Pub. Date: Feb. 29, 2024

(54) DEVICE ENABLING REGULATION OF CRYPTOCURRENCY TRANSACTIONS

(71) Applicant: Ryan Kelly Nichols, Glen Allen, VA (US)

(72) Inventor: Ryan Kelly Nichols, Glen Allen, VA (US)

(21) Appl. No.: 18/493,163

(22) Filed: Oct. 24, 2023

Related U.S. Application Data
(60) Provisional application No. 63/402,677, filed on Aug. 31, 2022.

(51) Int. Cl. G06Q 20/38; G06Q 20/36

(52) U.S. Cl. CPC G06Q 20/382; G06Q 20/36; G06Q 20/381; G06Q 2220/00

(57) ABSTRACT

A device allowing entity regulating and taxation of cryptocurrency received by a merchant through operatively associating the device at a point of sale of the merchant. The device in digital communication with an exchange server providing a smart contract module and a digital wallet associated with each the merchant and a customer providing the merchant with a digital value transaction paid for with cryptocurrency. The exchange server configured to receive the digital value transaction by way of the device, wherein the exchange server converts the digital value transaction to a stablecoin reward that is distributed to each digital wallet.

### CROSS-REFERENCE TO RELATED APPLICATION

This application claims the benefit of priority of U.S. provisional application No. 63/402,677, filed 31 Aug. 2022, the contents of which are herein incorporated by reference.

### BACKGROUND OF THE INVENTION

The present invention relates to devices enabling regulation of cryptocurrency transactions and, more particularly, to a device enabling entity regulation and taxation of cryptocurrency rewards/transactions for merchants and customers alike.

Cryptocurrency, crypto-currency, or crypto is a digital currency designed to work as a medium of exchange through a computer network that is not reliant on any central authority, such as a government or bank, to uphold or maintain it. It is a decentralized system for verifying that the parties to a transaction have the money they claim to have, eliminating the need for traditional intermediaries, such as banks, when funds are being transferred between two entities.

Individual coin ownership records are stored in a digital ledger, which is a computerized database using strong cryptography to secure transaction records, control the creation of additional coins, and verify the transfer of coin ownership. Despite their name, cryptocurrencies are not considered to be currencies in the traditional sense, and while varying treatments have been applied to them, including classification as commodities, securities, and currencies, cryptocurrencies are generally viewed as a distinct asset class in practice. Some crypto schemes use validators to maintain the cryptocurrency.

Cryptocurrency does not exist in physical form (like paper money) and is typically not issued by a central authority. Cryptocurrencies typically use decentralized control as opposed to a central bank digital currency (CBDC). When a cryptocurrency is minted, or created prior to issuance, or issued by a single issuer, it is generally considered centralized. When implemented with decentralized control, each cryptocurrency works through distributed ledger technology, typically a blockchain, that serves as a public financial transaction database.

Separately, a digital wallet, also known as an e-wallet, is an electronic device, online service, or software program that allows one party to make electronic transactions with another party bartering digital currency units for goods and services.

Untaxable and uncontrollable cryptocurrency transactions are frustrating governmental agencies entrusted with tracking, taxing, and regulating such transactions. Specifically, when criminal and terrorist organizations use crypto to bypass laws and sanctions, as these organizations' accounts are held on cryptocurrency exchanges. A cryptocurrency exchange, or a digital currency exchange (DCE), is a business that allows customers to trade cryptocurrencies or digital currencies for other assets, such as conventional fiat money or other digital currencies. Exchanges may accept credit card payments, wire transfers or other forms of payment in exchange for digital currencies or cryptocurrencies.

The problem with current cryptocurrency regulatory methods and related hardware devices is that they are not being used correctly in application. Most or all are using it in a very narrow-minded fashion, only focusing on today's overhead and not tomorrow's results. Which explains why governments have not moved forward with crypto currency reform and regulation. In short, current methods do not work well because they are not being used right.

As can be seen, there is a need for a device allowing entity regulating and taxation of crypto currency rewards/transactions for merchants and customers alike.

### SUMMARY OF THE INVENTION

The present invention gives the government a way to track the parties responsible for generating transactions that have cryptocurrency attached. The present invention would also generate these results if a free enterprise entity were to produce/distribute the device embodied in the present invention.

As a result, the present invention gives a regulatory body the ability to move forward with cryptocurrency reform and regulation.

In one aspect of the present invention, a digital transactional regulatory system, the system provides the following: a digital transactional device operatively associated with a merchant; an exchange server providing: a digital wallet module; a smart contract module; a memory for storing processor-executable instructions; a network interface for sending and receiving value and rewards transactions via a network; and a processor, coupled to the memory and the network interface, for executing the processor-executable instructions that causes the exchange server to: receive, by the processor via the network interface by way of the digital transactional device, a value transaction between a customer and the merchant; generate, by the smart contract module, a customer reward and a merchant reward, each reward in stablecoin, wherein each reward is based on a value transaction; distribute, by the processor via the network interface, the customer reward to a customer account residing in the digital wallet; and distribute, by the processor via the network interface, the merchant reward to a merchant account residing in the digital wallet, wherein the merchant reward is the value transaction less a fee associated with converting the value transaction to a stablecoin.

In another aspect of the present invention, the digital transactional regulatory system includes, wherein the digital transactional device is blockchain enabled to record the value transaction in a blockchain ledger, wherein the digital transactional device is operatively associated with a point of sale of the merchant, wherein the digital transactional device is a plug-in device configured to physically interface with a physical object capable of initiating a digital transaction, wherein the stablecoin is fiat monies associated with a regulatory body, wherein the regulatory body configures the exchange server, wherein the fiat monies is United States Coin, wherein the exchange server remits, by the processor via the network interface, to the regulatory body a value tax based on an amount of stablecoin in said merchant account, and wherein the customer reward is a fraction of the fee.

These and other features, aspects and advantages of the present invention will become better understood with reference to the following drawings, description, and claims.

### BRIEF DESCRIPTION OF THE DRAWINGS

FIG. 1 is a schematical diagram of an exemplary embodiment of the present invention, illustrating the enablement of entity regulation and taxation of cryptocurrencies.

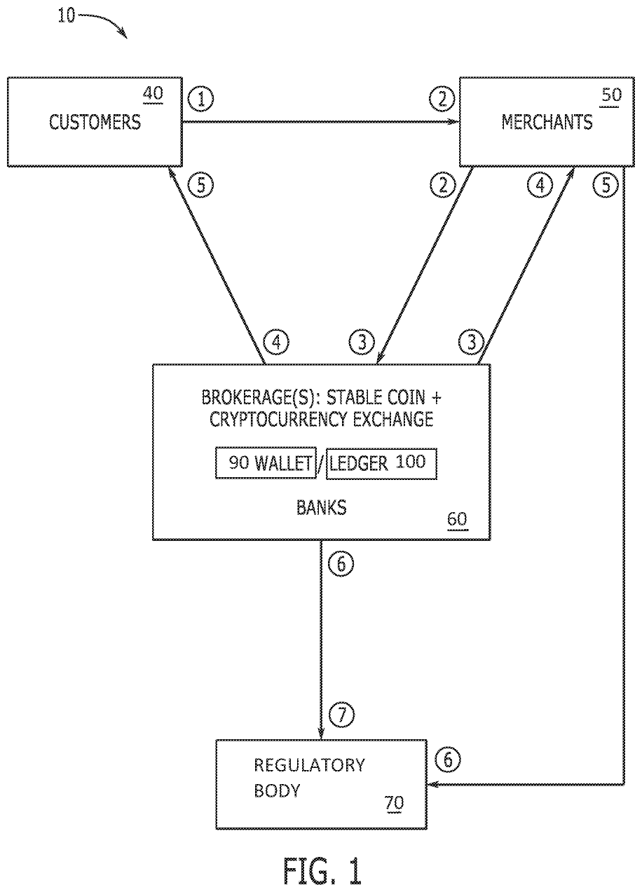

FIG. 2 is a schematical diagram of an exemplary embodiment of the present invention, illustrating transactions thereof.

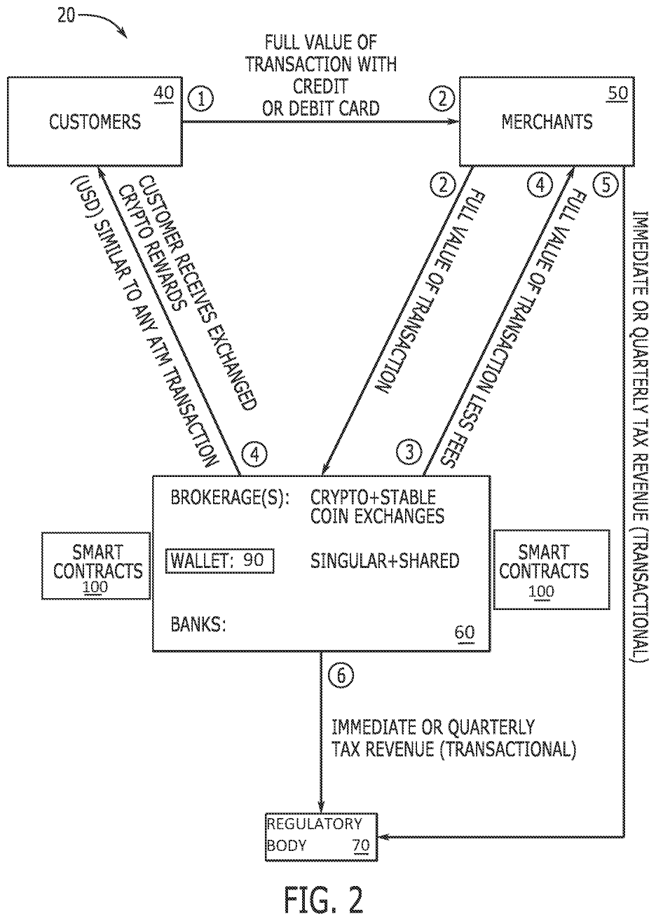

FIG. 3 is a schematic view of an exemplary embodiment of the present invention.

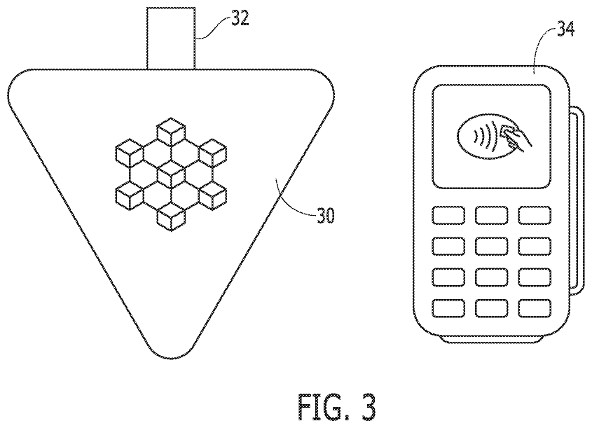

FIG. 4 is a block diagram of a general and/or special purpose computer 500, which may be a general and/or special purpose computing device, in accordance with some of the example embodiments of the invention. The computer 500 may be, for example, a user device, a user computer, a client computer and/or a server computer, among other things.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a system for regulating cryptocurrencies by mandating a specific relationship between a customer, the merchants engaging in a digital transaction with the customer, the cryptocurrency exchange(s) enabling such digital transactions, and a regulatory body, such as a governmental agency or the like. This relationship is configured by a systemic device of the present invention that governs a sequence of transactions, and thus defines a novel paradigm for crypto transactions.

On a broad level, in this paradigm, a merchant is required to process the digital transactions, while the cryptocurrency exchange and associated digital wallet exist to facilitate a systemic exchange of the underlying cryptocurrency and stablecoin (stablecoin is a type of cryptocurrency where the value of the digital asset is supposed to be pegged to a reference asset such as fiat money [e.g., the United States coin, USC, or United States Tether, UST], exchange-traded commodities [such as precious metals or industrial metals], or as a function as centralized or decentralized finance. The digital wallet exists to keep a documented ledger of all transactions and their systemic reward proceeds. The digital wallet also exists to facilitate the movement of both digital and psychical currency. The regulatory body exists to monitor all of this and dictate monetary policy accordingly.

On a more granular level, customers initiate digital transactions with merchants like the traditional model, though the merchants process these digital transactions using the innovative model of the present invention: routing revenue and rewards proceeds to and from the digital wallet to facilitate a regulatory paradigm. The digital wallet is connected to a cryptocurrency exchange that provides exchange for the crypto and commensurate stablecoin currency. The cryptocurrency exchange may be affiliated with one or more financial institutions regulated by the regulatory body; for instance, wherein the regulatory body is the United States, the financial institution is a FDIC insured bank. The financial institution acts as backer for stablecoin transactions or cash out request initially. They also facilitate all ATM transactions for the entire process through already issued debit cards.

Enabling the present invention would require a digital brokerage initially and a substantial amount of money would be required to develop a prototype for the merchant-end smart contract processing device 10, a digital wallet/application, and an association with the regulatory body and financial institutions.

The merchant's transfer of the entire transaction amount to the exchange happens automatically, this is not optional. The full amount of the transaction is then transferred back to the merchant, less any fees or crypto rewards. The rewards generated from transactions for loyal customers will reside in the digital wallet. The customer's registration with this wallet is not optional. This choice of wallet is set forth by the regulatory body. The brokerage, financial institutions, and digital exchanges will pay transactional tax revenue to the regulatory body by instantaneous or quarterly transfer of stablecoins. The merchants will also pay transactional tax revenue to the regulatory body (e.g., federal government). This may happen by instantaneous or quarterly stablecoin payment. Th relational arrangement of the paradigm disclosed herein is critical to the advantages of the present invention.

The system hardware device 10 at all merchant's point of sale will facilitate the system of the present invention.

### The Device/Software Function:

The systemic device 10 of the present invention may be a countertop or wall mounted unit 34 that a customer would swipe or tap at checkout. ‘Merchant Ended’, the systemic device 10 may also be a blockchain-powered plug-in 30 (wherein the plug 32 enables the device 10 to plug into a mobile device—e.g., a tablet or phone), as shown in the drawings. The systemic device 10 could be Bluetooth™ compatible and operate equally within the blockchain and physical realms of transaction.

Each action or step of function would trigger the next outcome including, but not limited to data collection and data transformation facilitated by a smart contract module 100. Percentages added to and subtracted from would be automatic and in real time. Gross and net amounts of transactions calculated/distributed to all parties are instantaneous.

Systemic device 10 may generate ‘cryptophysical’ (physical world transactions with crypto/digital rewards) Transactions occur in a highly predictable fashion, making calculations with trackable, and finite precision (‘Merchant Ended’).

A blockchain ledger would be required to house each transaction publicly. The ledger is mandatory for the regulatory body 70.

A smart contract module 100 may be provided instructions to a computing device to power at least some of the functionality of the systemic device 10. Calculating a percentage of the gross value of the purchase or transaction and adding cryptocurrency or stablecoin rewards to the customer's affiliate digital wallet application is facilitated by the functionality of the systemic device 10. Inevitably, more traditional rewards such as coupons and vouchers will be encouraged.

All customers 40 or shoppers will now receive digital rewards, also known as loyalty, or membership points, in the form of stablecoin, each time they swipe or tap their card/phone at checkout.

The rewards may be delivered to the customer's affiliate wallet in the form of regulatory body-chosen stablecoin. The digital rewards or stablecoins would then be redeemable for cash (USD, EURO, POUND, etc.) or any other cryptocurrency. The systemic device 10 is not offered yet due to the regulatory climate in America surrounding cryptocurrency/digital currency.

The systemic device 10 and configured functionality, will operate and generate transactions on the blockchain ledger. The ledger will be housed and operated by the affiliate application(s)/digital wallet. Server space will be the commodity that allows the ledger to exist. The overall system may be paid for or financed by the merchants and similarly, the brokerages that operate the affiliate applications/digital wallets.

Ledgers are used to keep digital records of open-source cryptocurrency and stablecoin transactions created by brokerages and their connected wallets. One centralized (open sourced and public) ledger may be required for USA/Global Government Regulation of this process.

### Process:

As mentioned above, a shared and open-source ledger wallet will exist. Run by a cryptocurrency exchange and operated for the regulatory body.

This digital wallet will house the ledger of all transactions. This is a secure, and public, digital portfolio capable of storing Stablecoin, cryptocurrency, USD, or other FIAT, NFT, Traditional Corporate Rewards, as well as the following:
Secured Property (Real Estate)/Fixed Income Investments.
Secured Property (Real Estate)/All income Investments within a Metaverse or similar digital marketplace realm.
Powered independently by the Blockchain and regulated by Smart Contract's internal functions. Step by Step is as follows.

The process begins with a customer 40 initiating a transaction with merchant (vendor) 50 swiping or tapping or otherwise operatively associating with the systemic device 10 via a Debit Card, Credit Card, or their phone using a Person to Person/Person to Business transfer service such as Apple Pay™, PayPal™′ Venmo™, CashApp™, Zelle™, or any other future competitors within this space. The Full Gross Value of the transaction is then sent to the merchant 50 via their merchant's processing device 10. The merchant 50 processes the transaction using the systemic device 10.

The total value of the transaction is then sent to the digital exchange 60 for digital reward add-ons. Smart Contracts calculate the percentage of digital rewards (stablecoin and cryptocurrency) owed to the customer based on the gross value of the transaction.

The cryptocurrency exchange 60 then sends the transaction's gross value back to the merchant 50 minus the digital rewards. Rewards are then also sent simultaneously/directly to the customer's affiliate wallet 90 in the form of stablecoin or cryptocurrency. A transactional fee is taken from the cryptocurrency exchange 60 for converting the fractional value of transaction into stablecoin or cryptocurrency. This fee can be shared with the merchant 50 and the regulatory body 70 (and regulated financial institutions 80) supporting the transaction. These functional aspects of the transaction are completed and served by Smart Contracts on an open sourced Blockchain.

The customer 40 then has the digital wallet 90 that keeps getting added to in the form of stablecoin and cryptocurrency rewards, based on the amount of times they swipe or tap their debit/credit card. Ideally, this wallet should be made into a mandatory savings account. Quarterly or Annual payouts from the cryptocurrency exchange 60/app that houses their wallet 90, and facilitates the transactions/ledger, with all its functions. The money will be staked and leveraged to generate consistent returns in all markets. Ready Quarterly or Annually for distribution payments to the participating ‘members’ or customers.

The participating merchants 50 are required to pay immediate sales tax revenue to regulatory body 70 (e.g., the state and federal government), or they are allowed to do so on a quarterly/yearly fashion as usual.

The cryptocurrency exchange 60 and financial institutions 80 may be required to pay immediate capital gains/sales tax on their transactional revenue or they are allowed to do so on a quarterly/annual basis as usual.

Customers/members 40 receiving more than $10,000 in annual digital rewards (stablecoin or cryptocurrency) may be required to submit the gains as capital or gift on that year's tax return/

Thereby, a goal of encouraging participants to save their returns and reinvest them, analogous to a Pension/Savings/ROTH similar/3-12 Month Money Market to be cashed in as hardship dictates, may be dictating according to the ‘Terms of Agreement & Options’.

In certain embodiments, the cryptocurrency exchange 60 is to pay out these distributions in the form of stablecoin or the customer chosen cryptocurrency. By holding onto these assets in an institutional fashion, the systemic device 10 and process effectively hedges against the previously wild swings in valuation from both BTC and ETH. 300 million new “buys” daily and no “sells” for a 3-12 month period creates the highly predictable patterns for the affiliate cryptocurrencies, and the stablecoin(s) if they have appreciative potential. The banks would be called upon to provide the initial cash or fiat support for the distributions, assuming the customers or ‘members’ wanted to exchange their digital rewards/stablecoin or cryptocurrency at time of distribution (e.g., 3-12 months). They would also have the option of “rolling over” or reinvesting their returns into the next time of distribution. This would be highly encouraged with incentives such as “APY” or percentage points on top of their principal balance.

The cryptocurrency exchange 60 may be adapted to generate short-, mid-, and long-term revenue from the daily swipe tap transactions the device creates with Merchants and their customers. The brokerage may also plan to leverage its client's collateral to best serve existing best practice/FDIC guidelines, and long-term wealth. With reinvestment/annual roll over options and encouragements.

### Government Oversight

‘Data’ or ‘Crowd Support’ is a development option or process of obtaining data from large numbers of sources to generate the unique and complex requirements or insights of that corporate function.

This describes using excess ‘space’ or ‘data’ from mobile device capacity each month as a business model. Companies monetize the additional space on public/private devices such as cell phones and tablets.

In this case we would be using “Crowd Supported” data from each participating member's computer, to facilitate and process the transactions. Thus, requiring no actual server space as a startup for the concept.

By sharing the cost of said ‘Crowd Data Center’, aka using excess space on the phones of those that swipe or tap their debit/credit cards at participating merchants, we do not have to sacrifice vital revenue in the beginning for server space to store the ledger of transactions. We also create a path for the Federal Government to keep a close eye on Cryptocurrency. They would have access to the phones of all that participated with this feature.

The ‘User Terms of Agreement’ would clearly stipulate the waiving of rights for participation. The Federal Government would be best to monitor closely through participating parties' mobile computing devices according to the terms of agreement.

It would also be smart to back up any public/open-source ledger offered by the brokerage with government servers. Capable of housing each transaction's data for an undisclosed/disclosed amount of time.

Transactions and the revenue they generate are already considered a model for many companies, both private and public. They fuel top and bottom lines, making the function of a transaction very similar already to a commodity. An almost set number of units is captured daily, pushing the remaining into the following day, to round out even and predetermined numbers for the day, weeks, and quarter.

When we begin attaching digital rewards and coin options onto this model, it will turn into a commodity. The process will allow for a 3× multiple on current daily best practices in the crypto/crypto physical/and real transactional industry simultaneously. Once all three are moving in unison, a commodity is formed. Highly predictable patterns for the model and the wheels that make it spin. (BTC/ETH/USDC/USDT/USD). (Affiliate proof of stake coin needed)

‘Futures’ contracts on all the above will become realistic. Few—Several companies with values in excess of a Trillion dollars will be formed. Daily ‘Options’ could be offered in the form of calls and puts. An official secondary market for Cryptocurrencies and Digital Rewards aka NFT's or Coupons, will be formed. One that is functional and regulated highly. Like the NYSE.

Each large company that is publicly traded will be able to “mint” or establish their own commodity. In the form of NFT or digital rewards, it's value is determined and backed up by their daily transactions. Once this happens, a fully “tokenized economy” will be formed and born. Adding Trillions, upon Trillions of dollars to our system we call Capitalism, and collectively to their valuations. It is to be shared with the people. “Transactionalism”

Cyclical in nature, it will affect the target country or continent/currency specific. Its function is based off local currencies. (USA/USD, EU/EURO, UK/POUND, etc.)

Tax revenue on each transaction goes to the federal government. Determined and set forth by private or public contract. It will create a surplus of digital dollars or stablecoins if that is desired. It will create a surplus of USD eventually as well. How much is kept, in what form, would be up to the local federal government.

Revenue is also shared with the key components powering this idea/process. The merchants and customers. Also, determined by contract, a percentage of each transaction will go back to the merchant and person swiping their debit/credit/or tapping a device. In the forms of cryptocurrency, stablecoin, and or digital rewards.

Stablecoin is maintained in an affiliate wallet. If the amount of these rewards surpasses federal taxation guidelines, the merchant or customer would also be required to pay capital gains on this money annually to your local federal government.

In some embodiments, there is a relation to the exchange/brokerage holding “digital rewards” or “coins” for the customers in the wallet, wherein the chief revenue driver for most cryptocurrencies held within the wallet will fall under the term: ‘Short Term’ BTC/ETH Trading, which is an investment tool using artificial intelligence to time the buys and sells; doing so through a “Node” it's capturing daily returns for investors.

This would be designed into functionality of the wallet. Encouraging customers to hold their rewards or coins instead of instantly selling them for Stablecoin or USD.

Regulation is coming. Merchant ended device will be a required portion of the process. Attaching digital currencies to each and every transaction will solidify cryptocurrency as the vital resource we need it to be. Tax ID numbers and a crowd supported/federal servers' public ledger will facilitate this.

Additionally, the present invention is applicable in other fields and forms where digital transactions drive relationships between two or more parties where an intermediary for regulatory purposes. For instance, the present invention may be used secondary in the digital universe (“Metaverse”), wherein the systemic arrangement of the present invention facilitates digitally transactions and connections by way of the systemic device, thereby processing real life and digital transactions safely. By transacting in the digital and real space simultaneously, the device embodied by the present invention will create specific niche opportunities. Some of which may disrupt current industries.

In certain embodiments, any coin kept in the attached wallet will be subject to, or qualify for ‘short term trading’. Daily gains are to be had by powering nodes to calculate trade schedules on BTC/ETH/and similar stable or digital assets. The terms of service or agreement will vary depending on the direction (upwards and downwards), that the affiliate cryptocurrency is moving. Consistent gains will be guaranteed. Accordingly, a faithful and highly regulated tool for long term investment is born. “Guaranteed Daily Dividends” make an APY or ROI predictable and viable. Private Equity and ‘Fractional Property’ Returns on Investments (ROI), such as Airbnb or Multi Family dwellings will be possible too on a monthly or quarterly basis. Customers are to be encouraged to hold their daily gains/reinvest them into the following day, week, month and ideally year over year. This is referred to as a “DRIP” or ‘Dividend Reinvestment Program’. Once established customers/clients are holding their gains for months and years at a time, we have effectively created a “pension” or “pension fund” of sorts. The brokerage/exchange will then have the ability to manage the fund as a hedge, or growth of capital model. Delivering consistent gains in equity, bond, and private/public capital markets globally directly from the affiliate or customer's wallet. Funded by their credit and debit card transactions, Digital Assets accumulate value. Reinvested daily. Terms of Service/User Agreement will stipulate the program details.

The computer 500 may include without limitation a processor device 530, a main memory 535, and an interconnect bus 537. The processor device 530 may include without limitation a single microprocessor or may include a plurality of microprocessors for configuring the computer 500 as a multi-processor system. The main memory 535 stores, among other things, instructions and/or data for execution by the processor device 530. The main memory 535 may include banks of dynamic random-access memory (DRAM), as well as cache memory.

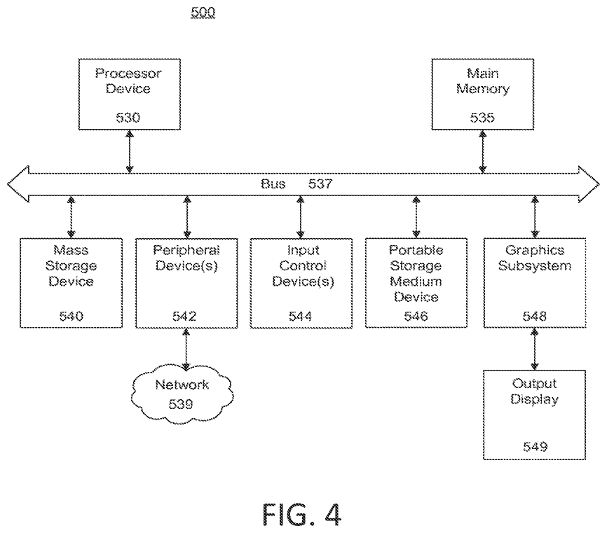

The computer 500 may further include a mass storage device 540, peripheral device(s) 542, non-transitory storage medium device(s) 546, input control device(s) 544, a graphics subsystem 548, and/or a display 549. For explanatory purposes, all components in the computer 500 are shown in FIG. 4 as being coupled through the bus 537. However, the computer 500 is not so limited. Devices of the computer 500 may be coupled through one or more data transport means. For example, the processor device 530 and/or the main memory 535 may be coupled through a local microprocessor bus. The mass storage device 540, peripheral device(s) 542, portable storage medium device(s) 546, and/or graphics subsystem 548 may be coupled via one or more input/output (I/O) buses. The mass storage device 540 may be a nonvolatile storage device for storing data and/or instructions for use by the processor device 530. The mass storage device 540 may be implemented, for example, with a magnetic disk drive or an optical disk drive. In a software embodiment, the mass storage device 540 is configured for loading contents of the mass storage device 540 into the main memory 535.

The portable storage medium device 546 operates in conjunction with a nonvolatile portable storage medium, such as, for example, a compact disc read only memory (CD-ROM), to input and output data and code to and from the computer 500. In some embodiments, the software for storing information may be stored on a portable storage medium and may be inputted into the computer 500 via the portable storage medium device 546. The peripheral device(s) 542 may include any type of computer support device, such as, for example, an input/output (I/O) interface configured to add additional functionality to the computer 500. For example, the peripheral device(s) 542 may include a network interface card for interfacing the computer 500 with a network 439.

The input control device(s) 544 provides a portion of the user interface for a user of the computer 500. The input control device(s) 544 may include a keypad and/or a cursor control device. The keypad may be configured for inputting alphanumeric characters and/or other key information. The cursor control device may include, for example, a handheld controller or mouse, a trackball, a stylus, and/or cursor direction keys. To display textual and graphical information, the computer 500 may include the graphics subsystem 548 and the output display 549. The output display 549 may include a cathode ray tube (CRT) display and/or a liquid crystal display (LCD). The graphics subsystem 548 receives textual and graphical information and processes the information for output to the output display 549.

Each component of the computer 500 may represent a broad category of a computer component of a general and/or special purpose computer. Components of the computer 500 are not limited to the specific implementations provided here.

Software embodiments of the example embodiments presented herein may be provided as a computer program product, or software, that may include an article of manufacture on a machine-accessible or machine-readable medium having instructions. The instructions on the non-transitory machine-accessible machine-readable or computer-readable medium may be used to program a computer system or other electronic device. The machine- or computer-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “computer-readable”, “machine-accessible medium” or “machine-readable medium” used herein shall include any medium that is capable of storing, encoding, or transmitting a sequence of instructions for execution by the machine and that causes the machine to perform any one of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Portions of the example embodiments of the invention may be conveniently implemented by using a conventional general-purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further include software for performing example aspects of the invention, as described above.

Included in the programming and/or software of the general and/or special purpose computer or microprocessor are software modules for implementing the procedures described above.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above-described example embodiments, but should be defined only in accordance with the following claims and their equivalents.

In addition, it should be understood that the accompanying figures are presented for example purposes only. The architecture of the example embodiments presented herein is sufficiently flexible and configurable, such that it may be utilized and navigated in ways other than that shown in the accompanying figures. Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

In embodiments referring to a network may be any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, Mac-OS, Windows, Unix, OpenVMS, an operating system based on Linux, or any other appropriate operating system, including future operating systems. In some embodiments, the computing systems may be a web server running web server applications such as Apache, Microsoft's Internet Information Server™, and the like.

In particular embodiments, the computing systems include a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface may include hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A digital transactional regulatory system, the system comprising:
a digital transactional device operatively associated with a merchant;
an exchange server comprising:
a digital wallet module;
a smart contract module;
a memory for storing processor-executable instructions;
a network interface for sending and receiving value and rewards transactions via a network; and
a processor, coupled to the memory and the network interface, for executing the processor-executable instructions that causes the exchange server to:
receive, by the processor via the network interface by way of the digital transactional device, a value transaction between a customer and the merchant;
generate, by the smart contract module, a customer reward and a merchant reward, each reward in stablecoin, wherein each reward is based on a value transaction;
distribute, by the processor via the network interface, the customer reward to a customer account residing in the digital wallet; and
distribute, by the processor via the network interface, the merchant reward to a merchant account residing in the digital wallet, wherein the merchant reward is the value transaction less a fee associated with converting the value transaction to a stablecoin.

2. The system of claim 1, wherein the digital transactional device is blockchain enabled to record the value transaction in a blockchain ledger.

3. The system of claim 1, wherein the digital transactional device is operatively associated with a point of sale of the merchant.

4. The system of claim 1, wherein the digital transactional device is a plug-in device configured to physically interface with a physical object capable of initiating a digital transaction.

5. The system of claim 1, wherein the stablecoin is fiat monies associated with a regulatory body, wherein the regulatory body configures the exchange server.

6. The system of claim 5, wherein the fiat monies is United States Coin.

7. The system of claim 5, wherein the exchange server remits, by the processor via the network interface, to the regulatory body a value tax based on an amount of stablecoin in said merchant account.

8. The system of claim 1, wherein the customer reward is a fraction of the fee.
